(19) United States
(12) Patent Application Publication
(10) Pub. No.: US 2026/0318373 A1
(43) Pub. Date: Oct. 15, 2026

(54) ROLLER SAFETY GEAR AND ARRANGEMENT

(71) Applicant: Winkel GmbH, Illingen (DE)

(72) Inventors: Alexander WEISSER, Pforzheim (DE); Jörg BERNHART, Bietigheim-Bissingen (DE)

(21) Appl. No.: 19/641,828

(22) Filed: Apr. 8, 2026

(30) Foreign Application Priority Data
Apr. 11, 2025 (DE) 102025114455.9

(51) Int. Cl. F16D 63/00; F16D 65/22; F16D 121/14; F16D 125/66

(52) U.S. Cl. CPC F16D 63/008; F16D 65/22; F16D 2121/14; F16D 2125/66

(57) ABSTRACT

A roller safety gear having a wedge body, and a tripping device arranged on the wedge body for movement relative to the wedge body in a longitudinal direction. Two safety rollers are rotatable relative to the wedge body and the tripping device, and the wedge body has a run-on slope for each of the safety rollers. A spacing of the run-on slopes with respect to one another increases longitudinally such that the slopes are arranged in a V-shape and a spacing, perpendicular to the longitudinal direction, of the run-on slopes is smaller in a starting region than in an end region. When the tripping device moves longitudinally, the safety rollers move from a release position, in which the safety rollers are arranged in the starting region of the respective run-on slope, in the direction of the end region of the respective run-on slope in the direction of a blocking position.

### CROSS-REFERENCE TO RELATED APPLICATION

This claims priority from German Application No. 102025114455.9, filed Apr. 11, 2025, the disclosure of which is hereby incorporated by reference in its entirety.

### TECHNICAL FIELD

The invention relates to a roller safety gear. The invention also relates to an arrangement having a traveling device, in particular a lifting device, at least one, in particular vertically arranged, traveling rail, wherein the traveling device is movable along the at least one traveling rail, and wherein the traveling rail has a U-shaped cross section or an I-shaped cross section with a base and at least two mutually opposite legs that extend from the base, and having a roller safety gear.

### BACKGROUND AND SUMMARY

Traveling devices, in particular lifting units and traveling units, are known and are used in all industrial sectors, for example as pallet lifts, generally in the field of material handling, or as automotive lifts during manufacture or in logistics.

The invention is intended to improve a roller safety gear and an arrangement.

A roller safety gear has a wedge body, at least one tripping device, wherein the tripping device is arranged on the wedge body so as to be movable relative to the wedge body in a longitudinal direction of the wedge body, and at least two safety rollers that are rotatable relative to the wedge body and to the tripping device, wherein the wedge body has, on each of two mutually opposite sides, a run-on slope for in each case one of the safety rollers, wherein a spacing of the two run-on slopes with respect to one another increases in the longitudinal direction of the wedge body such that the two run-on slopes are arranged in a V-shape and a spacing, measured perpendicularly to the longitudinal direction, of the run-on slopes with respect to one another is smaller in a starting region than in an end region, wherein, when the tripping device moves in the longitudinal direction relative to the wedge body, the safety rollers are moved from a release position, in which the safety rollers are arranged in the starting region of the respectively associated run-on slope, in the direction of the end region of the respectively associated run-on slope into a blocking position.

As a result, the roller safety gear can have a symmetric structure and is suitable for a traveling rail with a U-shaped cross section or an I-shaped cross section. The roller safety gear can have an extremely compact structure and can be arranged, in particular, between the legs of a U-rail or I-rail. As a result, the roller safety gear requires hardly any or even no additional installation space and is therefore particularly suitable in particular for the retrofitting of existing traveling devices. As a result of the symmetric structure, the roller safety gear can have a very compact structure since the forces applied to the safety rollers during a braking or blocking operation are introduced into the wedge body on two opposite sides and at least partially cancel each other out. The U-rail or I-rail does of course have to have sufficient statics, in other words have a sufficiently stable structure, in order to be able to withstand, without problems, the forces that arise when the safety rollers act on the rail and during the braking operation caused thereby. The tripping device can be formed in a wide variety of ways. The safety rollers can be moved mechanically, electrically, pneumatically or hydraulically from the release position into a contact position, starting from which the safety rollers, when the traveling device moves relative to the traveling rail, move automatically into the blocking position. The tripping device can be activated electromagnetically, electromechanically, for example by means of an electric motor, pneumatically or hydraulically even when it works mechanically, for example with levers, sliders and/or linkages, which are arranged vertically or laterally.

In a development of the invention, the at least two safety rollers have at least on one side an axle stub, especially axle stubs on both sides, wherein the axle stub is arranged in a guide slot.

In this way, the safety rollers can be guided safely when passing from a release position into a blocking position. The guide slots prevent the roller safety gear from being unintentionally tripped in the event of vibrations or significant accelerations of the traveling device. The safety rollers are held in the release position by means of the guide slots and cannot tip, for example, even in the event of vibrations, and so it is not possible for unintentional tripping of the roller safety gear to occur.

In a development of the invention there is at least one slotted plate that is provided with guide slots for the safety rollers.

By means of guide slots a good and reliable guiding of the safety rollers can be secured, at the same time with easy turnability of the safety rollers and a flat structure, i.e. not very high construction, of the roller safety gear. A flat structure of the roller safety gear makes it possible to arrange the latter entirely between the legs of the traveling rail, and so no additional installation space is required outside a contour defined by the traveling rail.

In a development of the invention, the wedge body is arranged between two slotted plates that are each provided with guide slots for the safety rollers.

In this way, good and reliable guidance of the safety rollers and, at the same time, an easily rotatable arrangement of the safety rollers in the case of a flat structure of the roller safety gear can be realized.

In a development of the invention, the tripping device has two tripping plates, wherein each of the tripping plates acts on in each case one of the safety rollers and each tripping plate is held on the wedge body so as to be movable in and counter to the longitudinal direction.

In this way, a very simple structure is realized, with which a blocking operation can be reliably initiated.

In a development of the invention, the tripping plates act on the circumference of the safety rollers.

By means of the tripping plates, the safety rollers are moved far enough out of their release position that the outer circumference of the safety rollers comes into contact with the traveling rail. Starting from this point, which can also be referred to as the contact position, the safety rollers then move automatically into the narrowing gap between the wedge body and the traveling rail.

In a development of the invention, each tripping plate has a portion extending parallel to the longitudinal direction and a portion that is angled in the direction toward the wedge body with respect to the longitudinal direction, wherein a circumference of the safety roller assigned to the tripping plate bears on the angled portion in the release position.

As a result of the angled portion of the tripping plate being moved, the safety roller is moved into a position in which its circumference comes into contact with the traveling rail, and starting from this position, the safety roller then moves automatically into the blocking position.

In a development of the invention, each tripping plate has, immediately before the transition from the portion extending in the longitudinal direction to the angled portion, a through-opening, the size of which is matched to the circumference of the safety roller such that, in the blocking position, a circumference of the safety roller can project at least partially through the through-opening.

As a result, not only is reliable and secure moving of the safety roller ensured when the tripping plates move, but it is also ensured that the circumference of the safety roller can come into contact with the traveling rail.

In a development of the invention, the tripping device has a tripping rocker or tripping component, which is held on the wedge body so as to be movable parallel to the longitudinal direction.

The tripping rocker or tripping component can be preloaded relative to the wedge body. For example, by means of a spring, a preload can be achieved between the wedge body and tripping component. The safety rollers are connected to the tripping component and can be moved together with the tripping component relative to the wedge body. Especially, the tripping plates can, for example, merely be hooked in the tripping component.

In a development of the invention the tripping component engages with the safety rollers.

In this way the safety rollers can be reliably moved relative to the wedge body. For example, the tripping component has a guiding slot on each side, one safety roller each being guided in a guiding slot.

In a development of the invention, a guide pin that extends parallel to the longitudinal direction and is connected to the wedge body is provided, wherein the tripping rocker is provided with a through-opening through which the guide pin extends.

By means of the guide pin, it is thus possible to guide the tripping rocker during a movement relative to the wedge body.

In a development of the invention, the guide pin is surrounded by at least one coil spring, which preloads the tripping device, in particular the tripping rocker, relative to the wedge body.

The tripping device can in this case be preloaded in the direction of the blocking position or in the direction of the release position, depending on the intended use of the roller safety gear. For example, when mechanical tripping of the roller safety gear is provided, the tripping device can be preloaded into the release position. In the case of electromagnetic tripping, provision may be made to preload the tripping device into the blocking position. In order to realize the different preloading directions, the coil springs can be arranged above or below the tripping rocker.

In a development of the invention, the tripping device is connected to an actuating rod that extends in the longitudinal direction.

For example, the tripping rocker or tripping component is connected to an actuating rod in an articulated manner.

In a development of the invention the actuating rod has two thickenings being arranged in distance from each other, whereby the actuating rod is guided by means of the thickenings in a housing.

By means of the thickenings, the actuating rod can be reliably guided.

In a development of the invention, the tripping device is connected to an actuator.

The actuator may be electromagnetic, electromechanical, for example in the form of an electric motor, pneumatic or hydraulic.

In a development of the invention, the actuator is arranged on a retaining component. The retaining component may be rigidly connected to the wedge body, in particular on a slotted plate.

In this way, the actuator can be arranged in a compact manner and the entire roller safety gear can, as a whole, have a flat structure such that it is arranged entirely between the mutually opposite legs of a U-shaped or I-shaped rail and requires no additional installation space.

An arrangement has a traveling device, in particular a lifting device, at least one, in particular vertically arranged, traveling rail, wherein the traveling device is movable along the at least one traveling rail, wherein the traveling rail has a U-shaped cross section or an I-shaped cross section with a base and at least two mutually opposite legs that extend from the base, and also a roller safety gear. The roller safety gear is connected to the traveling device, wherein at least the wedge body and the at least two safety rollers are arranged between the two mutually opposite legs of the traveling rail, wherein in each case at least one first safety roller of the roller safety gear is arranged directly next to, but spaced apart from the inner side of a first leg in a release position and bears against the inner side of the first leg in a blocking position, and wherein at least one second safety roller of the roller safety gear is arranged directly next to, but spaced apart from the inner side of a second leg in a release position and bears against the inner side of the second leg in a blocking position.

The base of the rail can also be referred to as the web and the legs of the rail can also be referred to as the flanges of the rail. The roller safety gear, since it acts on the inner sides of two opposite legs with its safety rollers, has only a very small space requirement. The roller safety gear can be arranged within the rail, and therefore requires hardly any or even no additional installation space and can generally be retrofitted without problems.

In a development of the invention, the roller safety gear is arranged entirely within a contour which is defined by the base and the two opposite legs of the rail.

Even in the case of very short legs or flanges of the rail, the roller safety gear can be successfully arranged entirely within the contour that is defined by the base, in other words the web, and the two opposite legs, in other words the flanges, of the rail.

In a development of the invention, means for moving the tripping device relative to the wedge body are provided.

These means can be activated mechanically, electrically, pneumatically or hydraulically for example by a speed monitoring device.

In a development of the invention, the means for moving have an actuator which is connected to the tripping device, in particular by means of an actuating rod, and is connected, in particular rigidly, to the wedge body by means of a retaining plate, which may be in the form, in particular, of a slotted plate.

In this way, a functionally reliable and at the same time compact roller safety gear is created. The entire roller safety gear including the actuator can be arranged within a contour that is defined by the base and the two opposite legs of the traveling rail, and so no additional installation space is required. The actuator can be electromagnetic, electromechanical, for example in the form of an electric motor, pneumatic or hydraulic.

In a development of the invention, the traveling rail extends in a vertical direction and the traveling device is in the form of a lifting and lowering device.

Further features and advantages of the invention will become apparent from the claims and the following description of preferred embodiments of the invention in conjunction with the drawings. Individual features of the different illustrated and/or described embodiments can be combined with one another as desired without departing from the scope of the invention. This also goes for the combination of individual features without further individual features in conjunction with which they have been illustrated and/or described. In the drawings:

### BRIEF DESCRIPTION OF THE DRAWINGS

FIG. 1 shows a view obliquely from above of a roller safety gear according to the invention according to a first embodiment;

FIG. 2 shows the roller safety gear from FIG. 1 with the front slotted plate remoted;

FIG. 3 shows an illustration in partial section of an arrangement having the roller safety gear in the state shown in FIG. 2 and a traveling rail in partial section;

FIG. 4 shows a sectional view of the arrangement in FIG. 3;

FIG. 5 shows a view of a roller safety gear according to the invention according to a second embodiment obliquely from above with the front slotted plate removed;

FIG. 6 shows an arrangement having the roller safety gear from FIG. 5 and a traveling rail in partial section;

FIG. 7 shows an illustration in partial section of the arrangement in FIG. 6;

FIG. 8 shows a schematic plan view of an arrangement having a traveling rail with a U-shaped cross section of a roller safety gear, and a traveling device;

FIG. 9 shows a schematic plan view of an arrangement having an I-shaped traveling rail and a roller safety gear;

FIG. 10 a view of a roller safety gear according to a further embodiment of the invention obliquely from the front;

FIG. 11 a first exploded view of the roller safety gear of FIG. 10;

FIG. 12 a second exploded view of the roller safety gear of FIG. 10;

FIG. 13 a third exploded view of the roller safety gear of FIG. 10;

FIG. 14 a view of the roller safety gear of FIG. 10 in a partly disassembled state;

FIG. 15 a partial sectional view of the roller safety gear of FIG. 10; and

FIG. 16 a front view of the roller safety gear of FIG. 10 in a partly disassembled state.

### DETAILED DESCRIPTION

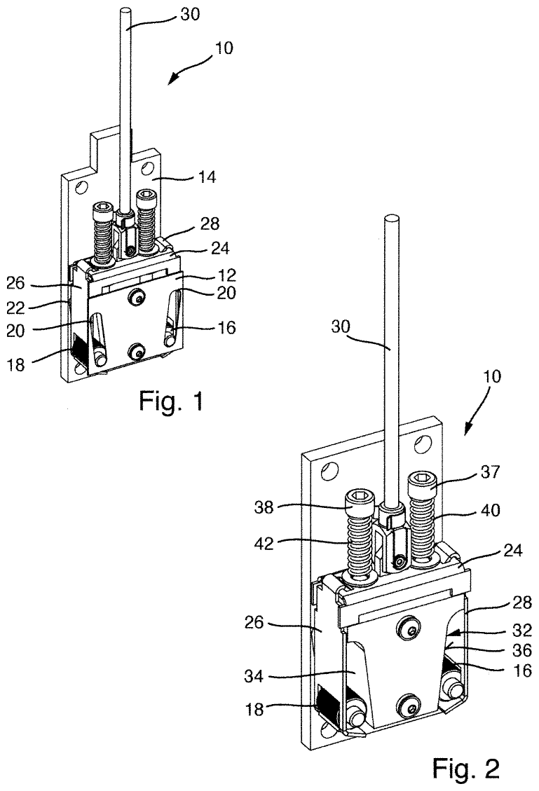

FIG. 1 shows a roller safety gear 10 according to the invention according to a first embodiment of the invention. The roller safety gear 10 has a front slotted plate 12 and a rear slotted plate 14, between which a wedge body, which is concealed in FIG. 1, cf. FIG. 2, is arranged. The slotted plates 12, 14 are rigidly connected to the wedge body 32 by means of screws. The wedge body 32 with one or with both slotted plates 12, 14 can also be formed in one piece and be manufactured, for example, from a solid part. The rear slotted plate can be connected to a traveling device (not illustrated), for example a lifting device. Two safety rollers 16, 18 each have axle stubs on both sides, wherein the axle stubs are arranged in guide slots 20 in the front slotted plate 12 and, respectively, in guide slots 22 in the rear slotted plate 14, this being apparent only in a very small portion in FIG. 1. Consequently, starting from the position illustrated in FIG. 1, the safety rollers 18 can moved upward and slightly outward.

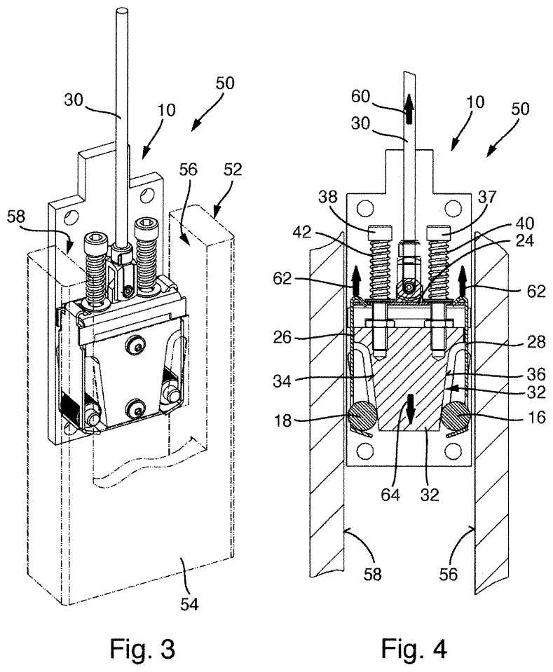

In the state in FIG. 1, the safety rollers 16, 18 are in a release position at the lower end of the guide slots 20, 22. In this release position, the circumference of the safety rollers 16, 18 is spaced apart from the inner sides of the legs of a traveling rail, cf. FIG. 3 and FIG. 4. When the roller safety gear 10, which is generally connected rigidly to a traveling device, moves relative to the traveling rail, the safety rollers 16, 18 are thus not set in rotation.

Only when the safety rollers are moved from the release position illustrated in FIG. 1 in the direction of a blocking position, i.e. upward in FIG. 1, does the outer circumference of the safety rollers touch the inner sides of the legs of the traveling rail and also run-on slopes of the wedge body. The safety rollers are then clamped between the wedge body and the inner sides of the legs of the traveling rail when the traveling device moves in the opposite direction, i.e. downward in FIG. 1. As a result, the safety rollers ensure that the roller safety gear 10 and thus also the traveling device connected to the roller safety gear 10 is braked until it comes to a standstill.

In order to move the safety rollers 16, 18 out of the release position in FIG. 1, a tripping device is provided, which has a tripping rocker 24, which can also be called a tripping component, and two tripping plates 26, 28 hooked on the tripping rocker 24. In the illustrated embodiment, the tripping rocker 24 is moved relative to the wedge body, upward in FIG. 1, by means of an actuating rod 30. As a result, the two safety rollers 16, 18 are displaced upward relative to the wedge body by means of the tripping plates until the outer circumference of each safety roller, cf. FIG. 4, comes into contact on one side with the adjacent inner side of a leg of the traveling rail and on the other side with the adjacent run-on slope of the wedge body. From this contact position, the safety roller then automatically moves a short way upward along the run-on slope of the wedge body until, in a blocking position, self-blocking occurs and a relative movement between the roller safety gear 10 and the traveling rail has been fully braked.

FIG. 2 shows the roller safety gear from FIG. 1 with the front slotted plate 12 removed. The wedge body 32 can be seen in this view. The wedge body 32 has a left-hand (in FIG. 2) run-on slope 34 and a right-hand run-on slope 36, which is concealed in FIG. 2. The two run-on slopes 34, 36 are arranged at an angle to a longitudinal direction of the wedge body 32, which extends from bottom to top in FIG. 2, such that a spacing, measured perpendicularly to the longitudinal direction, between the two run-on slopes 34, 36 increases in the longitudinal direction. The two run-on slopes 34, 36 are arranged in a V-shape with respect to one another as a result. At the upper end (in FIG. 2) of the run-on slopes 34, 36, said run-on slopes transition into a rounded portion, which runs to the respective outer side of the wedge body 32. This rounded portion may provide an emergency end stop if, during a braking operation, the safety rollers 16, 18 are actually displaced so far upward that their outer circumference bears on the respective rounded portion at the end of the respective run-on slope 34, 36.

It is also readily apparent from FIG. 2 that each of the tripping plates 26, 28 has, at an upper end, a hook-like formation, which is respectively hooked into the tripping rocker 24. As a result, the tripping rocker 24 can entrain the two tripping plates 26, 28 when it is pulled upward relative to the wedge body 32 from the release position in FIG. 2. The tripping rocker 24 has a U-shaped cross section. The tripping plates 26, 28 are each hooked into through-openings in the base of the tripping rocker 24. The ends of the legs of the tripping rocker 24 bear partially on side edges of the tripping plates 26, 28, such that a position of the tripping plates 26, 28 is stabilized and, in particular, the tripping plates 26, 28 are prevented from swinging in a lateral direction, i.e. into and out of the plane of the drawing in FIG. 2.

The tripping plates 26, 28 each have a portion which extends parallel to the longitudinal direction and a respective angled portion at the end opposite the hook-like formation which has been hooked into the tripping rocker 24. The angled portions are angled inwardly toward the wedge body 32 and the outer circumference of the safety rollers 16, 18 bears on the respective angled portion.

If the tripping rocker 24 is moved upward by means of a movement of the actuating rod 30 relative to the wedge body 32, the tripping plates 26, 28 are consequently also moved upward and the safety rollers 16, 18 are likewise displaced upward relative to the wedge body 32. As a result, the safety rollers 16, 18 come into the contact with the run-on slopes of the wedge body, cf. FIG. 4, and, as a result, are moved upward and simultaneously outward during the movement until they come into contact with the inner sides of the legs of the traveling rail, thereby initiating a braking operation.

The wedge body 32 is provided with two guide pins 37, 38, which are arranged parallel to the longitudinal direction and are in the form of bolts in the illustrated embodiment. The guide pins 37, 38 have been screwed, for example, into threaded holes in the wedge body 32, cf. FIG. 4. Each of the guide pins 37, 38 is surrounded, between a screw head and the tripping rocker 24, by a coil spring 40, 42. The coil springs 40, 42 exert on the tripping rocker 24 a preload force in the direction of the wedge body 32. By means of the coil springs 40, 42, the roller safety gear 10 is consequently preloaded into the release position in FIG. 1 and FIG. 2.

As has already been stated, in order to trip the roller safety gear, the actuating rod 30 has to be moved upward from the state illustrated in FIG. 2 counter to the action of the coil springs 40, 42. As a result, the tripping rocker 24 is also moved upward relative to the wedge body 32 and, by means of the tripping plates 26, 28, the safety rollers 16, 18 are moved from the release position in the direction of a blocking position. In the illustrated embodiment, the tripping device is tripped mechanically. Alternatively, the tripping device can be activated electromagnetically, electromechanically, for example by means of an electric motor, pneumatically or hydraulically even when it works mechanically, for example with levers, sliders and/or linkages, which are arranged vertically or laterally.

FIG. 3 shows an arrangement 50 having the roller safety gear 10 from FIGS. 1 and 2 and a traveling rail 52 illustrated partially in section. The traveling rail 52 has a base 54, which can also be referred to as a web, and two legs 56, 58 that project perpendicularly on the same side from the base 54 and can also be referred to as flanges. The traveling rail 52 is illustrated partially in section and partially by way of dashed lines in FIG. 3 in order to clarify the position of the roller safety gear 10 in the traveling rail 52.

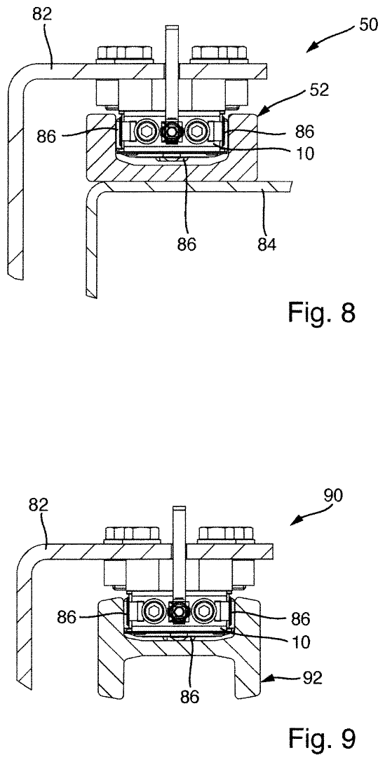

It is apparent from FIG. 3 that the roller safety gear 10 is arranged entirely within a contour, cf. also FIG. 8, which is defined by the base 54 and the two legs 56, 58 of the traveling rail 52. In other words, the roller safety gear 10 does not project beyond the free ends of the two legs 56, 58. As a result, the roller safety gear 10 can be arranged in an extremely space-saving manner and without the need for additional installation space. As a result, the roller safety gear 10 can be retrofitted very easily in existing traveling devices.

FIG. 4 shows a sectional view of the arrangement 50 in FIG. 3. The roller safety gear 10 is arranged between the two legs 56, 58 of the traveling rail 52. In the state in FIG. 4, the safety rollers 16, 18 are in the release position. An outer circumference of the safety rollers 16, 18 is already touching the respectively associated run-on slope 34, 36 of the wedge body 32. Furthermore, the outer circumference of the safety rollers 16, 18 bears on the angled portion of the tripping plates 26, 28. It is apparent that the tripping plates 26, 28 have been hooked by way of their hook-like ends, illustrated at the top in FIG. 4, into through-openings in the tripping rocker 24. The actuating rod 30 is connected to the tripping rocker 24 in an articulated manner. If the actuating rod 30 is pulled upward as per the arrow 60, the tripping rocker 24 and the tripping plates 26, 28 are also moved upward as per the arrows 62. Such a relative movement of the actuating rod 60 and of the tripping device with the tripping rocker 24 and the tripping plates 26, 28 relative to the wedge body 32 takes place during a downward movement of the roller safety gear as per the arrow 64. The entire roller safety gear 10 thus moves downward together with a traveling device (not illustrated) relative to the two legs 58, 56. If the actuating rod 30 is moved upward relative to the wedge body 32 as per the arrow 60, the safety rollers 16, 18, which bear on the angled portions of the tripping plates 26, 28, are likewise moved upward relative to the wedge body 32. As a result of the V-shaped arrangement of the two run-on slopes 34, 36, a spacing perpendicular to the longitudinal direction of the two safety rollers 16, 18 increases, and so, with the upward movement of the tripping device, the outer circumference of the safety rollers 16, 18 gets closer to the respectively associated inner side of the legs 56, 58.

If the safety rollers 16, 18 have been displaced upward to such an extent relative to the wedge body 32 that the outer circumference of the safety roller 16 contacts the inner side of the leg 56 and the outer circumference of the safety roller 18 contacts the inner side of the leg 58, the downward movement of the entire roller safety gear 10 as per the arrow 64 has the result that the safety rollers 16, 18 each move automatically further into the narrowing gaps between the run-on slopes 34, 36 and the inner sides of the legs 56, 58. The safety roller 16 will move into the narrowing gap between the run-on slope 36 and the inner side of the leg 56. The safety roller 18 will move into the narrowing gap between the run-on slope 34 and the inner side of the leg 58. This movement into the respectively narrowing gap is stopped when self-locking has been achieved. A movement along the arrow 64 of the roller safety gear 10 and of a traveling device connected to the roller safety gear 10 relative to the rail with the two legs 56, 58 is then braked to a standstill.

It is apparent from FIGS. 3 and 4 that each of the tripping plates 26, 28 has, immediately before the transition into the respective angled portion, a through-opening, which is rectangular in the illustrated embodiment. These rectangular through-openings make it possible for the respective safety roller 16, 18 to move with its outer circumference through the through-opening as far as a contact position in which the circumference of the respective safety roller bears against the inner side of the respectively associated leg 56, 58. However, the lateral webs of the tripping plates that delimit the through-opening prevent the axle stubs of the safety rollers 16, 18 from passing through the through-opening, and so the safety rollers 16, 18 remain in the release position illustrated in FIG. 3 and FIG. 4.

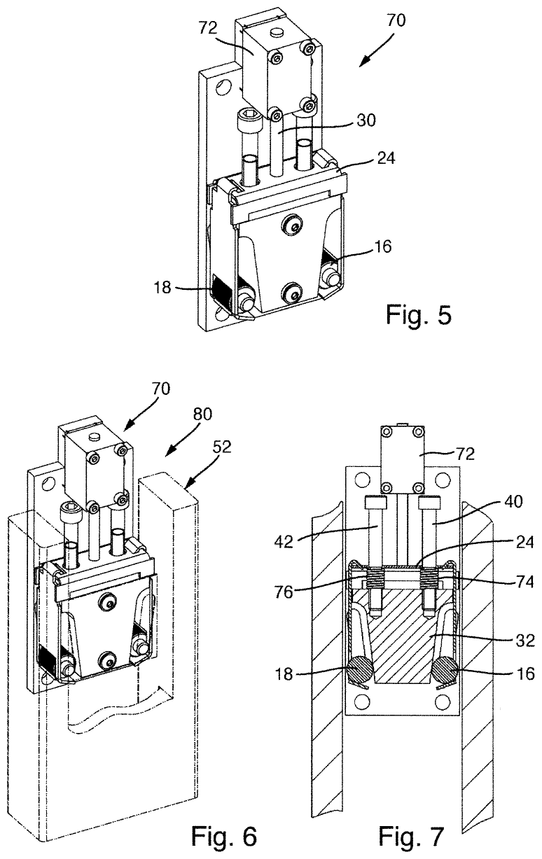

FIG. 5 shows a further roller safety gear 70 according to the invention according to a second embodiment of the invention. In the following text, only the differences of the roller safety gear 70 from the roller safety gear 10 in FIGS. 1 to 4 will be explained. A front slotted plate has been removed in the state in FIG. 5 and is not illustrated.

In the case of the roller safety gear 70, the actuating rod 30 is actuated by means of an electromagnetic actuator 72 according to the illustrated embodiment. The actuator may, however, be electromagnetic, electromechanical, for example in the form of an electric motor, pneumatic or hydraulic. The electromagnetic actuator 72 likewise moves the tripping rocker 24 upward, in order, as in the case of the roller safety gear 10 in FIGS. 1 to 4, to move the safety rollers 16, 18 from the release position illustrated in FIG. 5, cf. also FIGS. 6 and 7, into a blocking position. The electromagnetic actuator 72 is fastened to the rear slotted plate in FIG. 5.

As is apparent from the sectional view in FIG. 7, coil springs 74, 76 are arranged such that they surround the guide pins 40, 42. The coil springs 74, 76 are, however, arranged between the wedge body 32 and the tripping rocker 24 and thus preload the tripping rocker 24 upward in FIGS. 5 to 7. The roller safety gear 70 in FIGS. 5 to 7 is thus preloaded into the blocking position. By means of the electromagnetic actuator 72, the tripping rocker 24 is pushed downward into the release position illustrated in FIGS. 5 to 7. This takes place counter to the action of the coil springs 74, 76. If the electromagnetic actuator 72 is deactivated, i.e. such that it no longer exerts a pressure force on the actuating rod 30, the coil springs 74, 76 consequently push the tripping rocker 24 upward, with the result that the two safety rollers 16, 18 are also moved upward relative to the wedge body 32 from the release position in the direction of the blocking position. The tripping device can be activated electromagnetically, electromechanically, for example by means of an electric motor, pneumatically or hydraulically even when it works mechanically, for example with levers, sliders and/or linkages, which are arranged vertically or laterally. The actuator may be electromagnetic, electromechanical, for example in the form of an electric motor, pneumatic or hydraulic.

FIG. 6 shows a view in partial section of an arrangement 80 having the roller safety gear 70 in FIG. 5 and the traveling rail 52. It is apparent that the roller safety gear 70 can also be arranged entirely within a contour that is defined by the base and the legs of the traveling rail 52.

FIG. 8 shows a schematic illustration of the arrangement 50 with the U-shaped traveling rail 52 and the roller safety gear 10 arranged within the traveling rail 52. The arrangement 50 also has a traveling device 82, which is schematically illustrated only partially and which is embodied, for example, as a lifting carriage. The traveling device 82 acts on the traveling rail 52 by way of a plurality of rollers 86 that are only partially apparent in FIG. 8. It is apparent from FIG. 8 that the roller safety gear 10 according to the invention has an extremely compact structure and can be arranged within the traveling rail 52. Of course, the roller safety gear 10 is rigidly connected to the traveling device 82. The traveling device 82 can act on a second, likewise U-shaped traveling rail, which is arranged symmetrically with the traveling rail 52 on a lower side (in FIG. 8) of a mast 84 and is not illustrated in FIG. 8.

FIG. 9 shows AN arrangement 90 having a cross-sectionally I-shaped traveling rail 92 and the roller safety gear 10, which is mounted on the traveling device 82, which is illustrated only partially. The traveling device 82 acts on the traveling rail 92 by way of a plurality of rollers 86 that are only partially apparent in FIG. 9. The roller safety gear 10 requires so little installation space that it can be arranged between two mutually opposite legs of the I-shaped rail 92. The traveling device 82 can act on a second, likewise I-shaped traveling rail, which is arranged symmetrically with or parallel to the traveling rail 92 on a lower side (not illustrated in FIG. 9) of a mast and is not illustrated in FIG. 9.

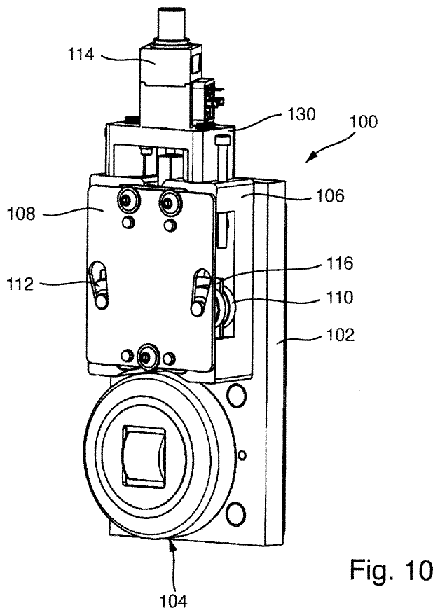

FIG. 10 shows a roller safety gear 100 according to a further embodiment of the invention. The roller safety gear 100 has a base plate 102, wherein on the base plate 102 an axial roller 104 is rotatably fixed.

Also mounted on the base plate 102 is a wedge body component 106. On the wedge body component 106 a slotted plate 108 is mounted and in between the slotted plate 108 and the wedge body component 106 two safety rollers 110, 112 are arranged, which are only partly visible in FIG. 10. In the same way as with the roller safety gear already described, the roller safety gear 100 is intended to be mounted within the contour of a U-shaped or I-shaped traveling rail, see FIGS. 8 and 9. The safety rollers 110, 112 can be moved by means of an actuator 114 upwards, which then causes an upward and outward movement of the safety rollers 110, 112 relative to the position shown in FIG. 10. Thereby, the safety rollers 110, 112 get jammed between a wedge body, said wedge body forming part of the wedge body component 106, and the traveling rail which is not shown in FIG. 10.

The two safety rollers 110, 112 are connected to a tripping component 116, which can also be called a tripping rocker. If the tripping component is moved upwards by means of the actuator 114, the safety rollers 110, 112 are moved upwards and outwards starting from the position shown in FIG. 10.

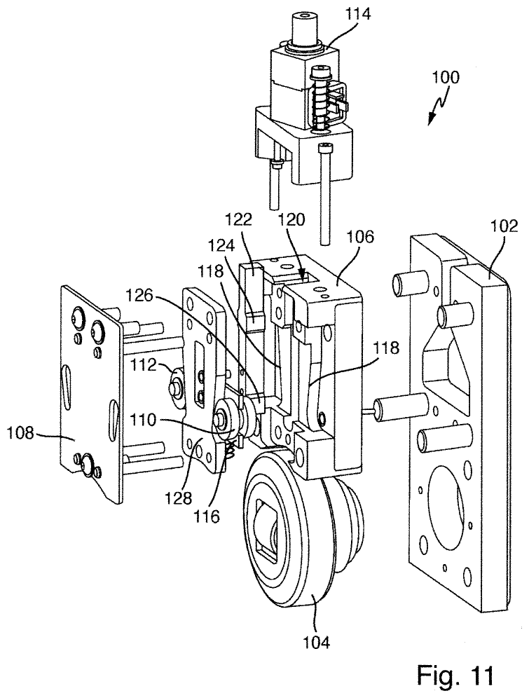

FIG. 11 shows a first exploded view of the roller safety gear 100 of FIG. 10. The base plate 102, the axial roller 104 as a well as the wedge body component 106 can be seen. The wedge body component 106 is provided with two run-on slopes or leading chamfers being arranged opposite to each other. By means of the run-on slopes the safety rollers 110, 112 are moved outwardly.

In between the two run-on slopes 118 a guiding groove 120 is provided in the wedge body component 106 for guiding an actuating rod 122. The actuating rod 122 is on the one side connected with the tripping component 116 and on the other side with the actuator 114. If the actuating rod 122 is moved by means of the actuator 114 upwards relative to the wedge body component 106, by means of the tripping component the two safety rollers 110, 112 are also moved upwards and by means of the run-on slopes 118 pushed outwardly during the upward movement. As has already been explained, the outer circumference of the safety rollers 110, 112 thereby come into contact with the tracks of the traveling rail, thereby creating a self-locking effect.

The actuating rod 122 is provided with two thickenings 124, 126, which enable a secure and smooth-running guidance of the actuating rod 122 in the guiding groove 120.

The safety rollers 110, 112 are each designed as double rollers. Each double roller has two single rollers which are arranged along the axis of rotation with a distance in between them. In between the single rollers, the tripping component engages. The tripping component has a u-shaped slot each on both ends, an intermediate section in between the two single rollers being arranged in this slot.

In addition to the run-on slopes 118 of the wedge body component 106 a wedge body plate 128 is provided, which is also provided with two run-on slopes being arranged opposite to each other. The run-on slopes of the wedge body plate are aligned in the mounted state of the wedge body plate 128 with the run-on slopes 118 of the wedge body component 106. The run-on slopes of the wedge body plate 128 are intended for the left single roller, see FIG. 11, of each of the safety rollers 110, 112, respectively. The run-on slopes 118 are intended for the right single roller, see FIG. 11, of each of the safety rollers 110, 112.

On the left side, see FIG. 11, of each of the safety rollers 110, 112 a stub shaft of the safety rollers 110, 112 protrudes. These stub shafts are guided each in a slot of the slotted plate 108.

The right side of the safety rollers 110, 112, which can not be seen in FIG. 11, does not have a stub shaft, see FIG. 10.

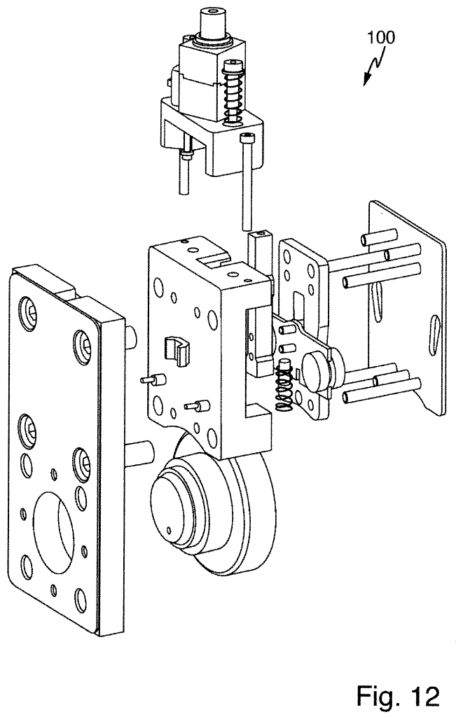

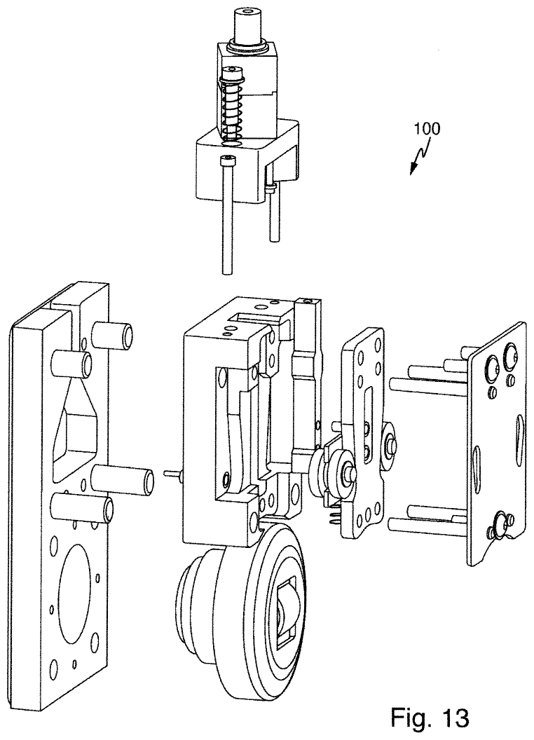

FIG. 12 shows the exploded view of FIG. 11 in a view from behind. FIG. 13 shows the exploded view of FIG. 11 from a different angle.

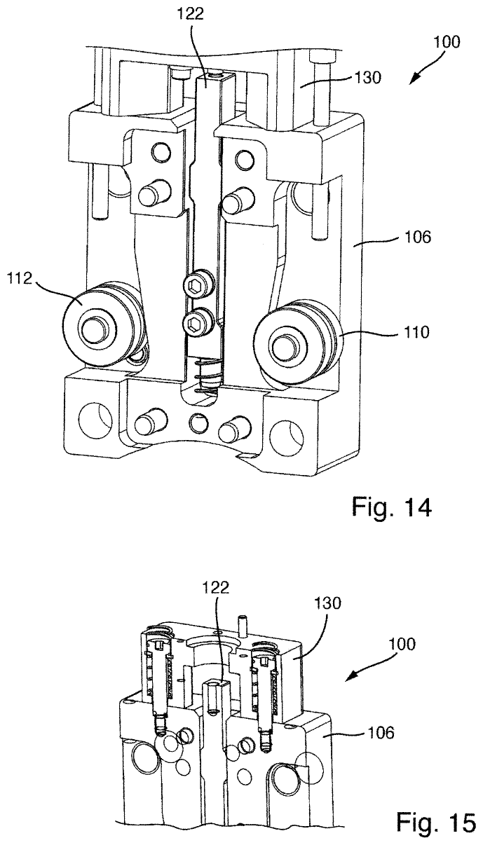

FIG. 14 partially shows the roller safety gear 100 of FIG. 10 in partly disassembled state. In the state of FIG. 14 only the wedge body component 106 with the two safety rollers 110, 112, a clamping plate 130 partly shown and the actuating rod 122 are shown.

FIG. 15 shows a partial sectional view of the roller safety gear 100 in a partly disassembled state. It can be seen in FIG. 15, that the clamping plate 130 is urged by means of springs against the wedge body component 106 and that the clamping plate 130 therefore can move against the action of these springs relative to the wedge body part 106 in the upward direction. On the clamping plate 130 the actuator 114 is mounted, see also FIG. 10. If the actuating rod 112 is moved by means of the actuator 114 upwards, the safety rollers 110, 112 are thereby moved upwards and at the same time moved outwardly by means of the run-on slopes 118. The safety rollers get then jammed in between the run-on slopes and the tracks of the traveling rails and are further moved upwards up to a complete standstill. Such an additional movement can be compensated for by the clamping plate 130, which then moves upwards a little bit together with the actuator 114.

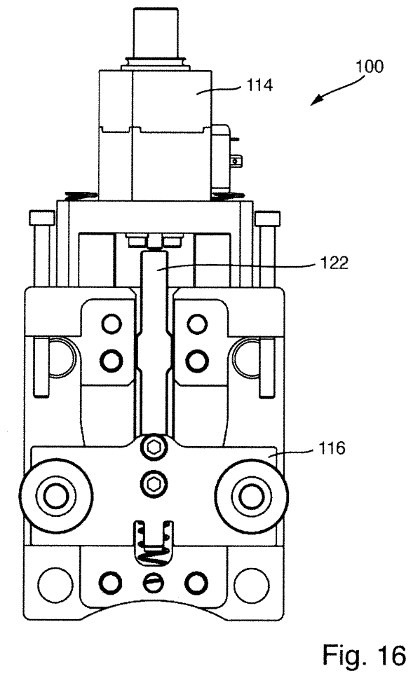

FIG. 16 shows the roller safety gear in a partly disassembled state in a front view. In contrast to the state of FIG. 14 the tripping component 116 is still mounted, the tripping component 116 being fixed by two screws on the actuating rod 122.

Altogether, by means of the invention an extremely reliable and compact roller safety gear 100 is provided, which can be mounted within a contour of a traveling rail.

1. A roller safety gear having a wedge body, at least one tripping device, wherein the tripping device is arranged on the wedge body so as to be movable relative to the wedge body in a longitudinal direction of the wedge body, at least two safety rollers that are rotatable relative to the wedge body and to the tripping device, wherein the wedge body has, on each of two mutually opposite sides, a run-on slope for each case of the safety rollers, wherein a spacing of the two run-on slopes with respect to one another increases in the longitudinal direction of the wedge body such that the two run-on slopes are arranged in a V-shape and a spacing, measured perpendicularly to the longitudinal direction, of the run-on slopes with respect to one another is smaller in a starting region than in an end region, wherein, when the tripping device moves in the longitudinal direction relative to the wedge body, the safety rollers are moved from a release position, in which release position the safety rollers are arranged in the starting region of the respectively associated run-on slope, in a direction of the end region of the respectively associated run-on slope in a direction of a blocking position.

2. The roller safety gear as claimed in claim 1, wherein the at least two safety rollers have at least on one side an axle stub, wherein the axle stub is arranged in a guide slot.

3. The roller safety gear according to claim 1, wherein at least one slotted plate is provided and has guide slots for the safety rollers.

4. The roller safety gear as claimed in claim 3, wherein the wedge body is arranged between two slotted plates that are each provided with guide slots for the safety rollers.

5. The roller safety gear as claimed in claim 1, wherein the tripping device has two tripping plates, wherein each of the tripping plates acts on one of the safety rollers and each tripping plate is held on the wedge body so as to be movable in and counter to the longitudinal direction.

6. The roller safety gear as claimed in claim 5, wherein the tripping plates act on a circumference of the safety rollers.

7. The roller safety gear as claimed in claim 5, wherein each tripping plate has a portion extending parallel to the longitudinal direction and a portion angled in a direction toward the wedge body with respect to the longitudinal direction, wherein a circumference of the safety roller assigned to the tripping plate bears on the angled portion in the release position.

8. The roller safety gear as claimed in claim 7, wherein each tripping plate has, immediately before a transition from the portion extending in the longitudinal direction to the angled portion, a through-opening, a size of the through-opening being matched to the circumference of the safety roller such that, in the blocking position, a circumference of the safety roller projects at least partially through the through-opening.

9. The roller safety gear as claimed in claim 1, wherein the tripping device has a tripping rocker or a tripping component held on the wedge body so as to be movable parallel to the longitudinal direction.

10. The roller safety gear as claimed in claim 1, wherein the tripping device is connected to an actuating rod that extends in the longitudinal direction.

11. The roller safety gear according to claim 10, wherein the actuating rod has two thickenings spaced from each other in the longitudinal direction, wherein the actuating rod is guided by means of the thickenings in a housing.

12. The roller safety gear as claimed in claim 1, wherein the tripping device is connected to an actuator.

13. The roller safety gear as claimed in claim 12, wherein the actuator is arranged on a retaining plate that is, in particular rigidly, connected to the wedge body, in particular on a slotted plate.

14. An arrangement comprising:
a traveling device;
at least one traveling rail, wherein the traveling device is movable along the at least one traveling rail and the traveling rail has a U-shaped cross section or an I-shaped cross section with a base and at least two mutually opposite legs that extend from the base;
a roller safety gear connected to the traveling device, the roller safety gear comprising:
a wedge body;
at least one tripping device, wherein the tripping device is arranged on the wedge body so as to be movable relative to the wedge body in a longitudinal direction of the wedge body;
at least two safety rollers that are rotatable relative to the wedge body and to the tripping device, wherein the wedge body has, on each of two mutually opposite sides, a run-on slope for each of the safety rollers, wherein a spacing of the two run-on slopes with respect to one another increases in the longitudinal direction of the wedge body such that the two run-on slopes are arranged in a V-shape and a spacing, measured perpendicularly to the longitudinal direction, of the run-on slopes with respect to one another is smaller in a starting region than in an end region, wherein, when the tripping device moves in the longitudinal direction relative to the wedge body, the safety rollers are moved from a release position, in which release position the safety rollers are arranged in the starting region of the respectively associated run-on slope, in a direction of the end region of the respectively associated run-on slope in a direction of a blocking position, wherein at least the wedge body and the at least two safety rollers are arranged between the two mutually opposite legs of the traveling rail, at least one first safety roller of the roller safety gear is arranged directly next to but spaced apart from an inner side of a first of the legs in the release position and bears against the inner side of the first leg in the blocking position, and at least one second safety roller of the roller safety gear is arranged directly next to but spaced apart from the inner side of a second of the legs in the release position and bears against the inner side of the second leg in the blocking position.

15. The arrangement as claimed in claim 14, wherein the roller safety gear is arranged entirely within a contour defined by the base and the two opposite legs of the rail.

16. The arrangement as claimed in claim 14, comprising means for moving the tripping device relative to the wedge body.

17. The arrangement as claimed in claim 16, wherein the means for moving comprises an actuator connected to the tripping device, in particular by means of an actuating rod, and is connected, in particular rigidly, to the wedge body by means of a retaining plate.

18. The arrangement as claimed in claim 14, wherein the traveling rail extends in a vertical direction and the traveling device comprises a lifting and lowering device.

19. The arrangement as claimed in claim 14, wherein the traveling device comprises a lifting device, and the traveling rail is oriented vertically.
